(19) United States
(12) Patent Application Publication
(10) Pub. No.: US 2007/0252778 A1
(43) Pub. Date: Nov. 1, 2007

(54) Pure Dielectric Antennas and Related Devices

(76) Inventors: Jonathan Ide, Cambridge (GB); Simon Philip Kingsley, Cambridge (GB); Steven Gregory O'Keefe, Queensland (AU); Seppo Saario, Cambridge (GB)

Correspondence Address: PEARL COHEN ZEDEK LATZER, LLP, 1500 BROADWAY 12TH FLOOR, NEW YORK, NY, 10036, US

(21) Appl. No.: 11/792,079

(22) PCT Filed: Jan. 17, 2006
(86) PCT No.: PCT/GB06/00144

§ 371 Date: Jun. 1, 2007

(30) Foreign Application Priority Data
Jan. 17, 2005 (GB) 0500856.0

(51) Int. Cl. H01Q 1/38

(52) U.S. Cl. 343/907

(57) ABSTRACT

There is disclosed an antenna device comprising an elongate dielectric radiating element having a longitudinal axis and a feeding mechanism for generating displacement currents in the dielectric radiating element. The radiating element is configured to support displacement current resonance modes parallel to the longitudinal axis but to inhibit displacement current resonance modes transverse to the longitudinal axis.

The present invention relates to novel antennas, in particular for RF applications, in which an elongate substantially purely dielectric component supports a novel mode of resonance.

### BACKGROUND

The present applicant has developed a new type of antenna technology that is based on substantially purely dielectric materials and yet which is believed to be different from both dielectric resonator antennas (DRAs) and electrically conductive antennas. Electrically conductive antennas such as dipoles can be almost infinitely thin if conductivity is sufficiently good, whereas the substantially purely dielectric antennas of embodiments of the present invention need a finite cross-section to radiate effectively. DRAs are volume devices that radiate like a cavity. It is not clear whether a DRA would turn into a purely dielectric antenna if it was made to be so long and thin that transverse resonant modes were no longer possible (at the frequencies of interest) because this subject has never been investigated.

Although no metal conductor appears to be theoretically necessary in a purely dielectric antenna, it is required in practice so that a feed network can be soldered to the antenna for testing. Agreement between simulations and laboratory measurements is good, thus indicating that the technology is real and not some simulation or measurement artifact.

Until recently antennas were always made from conducting materials such as copper. It seems almost counter-intuitive to try to design an antenna from dielectric (insulating) materials, but in fact at radio frequencies these materials will support a radiating displacement current. R. D. Richtmyer at Stanford University showed this as early as 1939 in a theoretical paper [RICHTMYER R. D.: “Dielectric resonators”, J. Applied Physics, 10, 391-398, 1939]. It was J. C. Maxwell who added the displacement current term to the equations that now bear his name. Obviously a displacement current cannot be a flow of free charge and it is actually caused by a displacement of the electrons about their mean position in the lattice structure. This is similar to the way in which another dielectric device, the capacitor, will not conduct direct current (DC) but will pass radio frequencies.

Dielectric antennas are antenna devices that radiate or receive radio waves at a chosen frequency of transmission and reception, as used, for example, in mobile telecommunications. The dielectric material of a dielectric antenna can be made from several candidate materials including ceramic dielectrics, in particular low-loss ceramic dielectric materials.

The present applicant has conducted wide-ranging research in the field of dielectric antennas, and the nomenclature given below will be used in the application. It is believed that the purely dielectric antenna of embodiments of the present invention adds a new category to these known types of dielectric, or dielectrically-based, antenna technology. The existing nomenclature, as used before this present invention, is:

High Dielectric Antenna (HDA): Any antenna making use of high dielectric components either as resonators or in order to modify the response of a conductive radiator.

The class of HDAs is then subdivided into the following:

a) Dielectrically Loaded Antenna (DLA): An antenna in which a traditional, electrically conductive radiating element is encased in or located adjacent to a dielectric material (generally a solid dielectric material) that modifies the resonance characteristics of the conductive radiating element. Generally speaking, encasing a conductive radiating element in a solid dielectric material allows the use of a shorter or smaller radiating element for any given set of operating characteristics, albeit at the expense of bandwidth and radiation resistance, see most text books on antenna theory [e.g. RUDGE A. W., MILNE K., OLVER A. D. and KNIGHT P.: “The handbook of antenna design”, Peter Peregrinus Press, 1986, page 1534]. In a DLA, there is only a trivial displacement current generated in the dielectric material, and it is the conductive element that acts as the radiator, not the dielectric material. DLAs generally have a well-defined and narrowband frequency response.

b) Dielectric Resonator Antenna (DRA): An antenna in which a dielectric material (generally a solid, but could be a liquid or in some cases a gas) is provided on top of a conductive groundplane, and to which energy is fed by way of a probe feed, an aperture feed or a direct feed (e.g. a microstrip feedline). Since the first systematic study of DRAs in 1983 [LONG, S. A., McALLISTER, M. W., and SHEN, L. C.: “The Resonant Cylindrical Dielectric Cavity Antenna”, IEEE Transactions on Antennas and Propagation, AP-31, 1983, pp 406-412], interest has grown in their radiation patterns because of their high radiation efficiency, good match to most commonly used transmission lines and small physical size [MONGIA, R. K. and BHARTIA, P.: “Dielectric Resonator Antennas—A Review and General Design Relations for Resonant Frequency and Bandwidth”, International Journal of Microwave and Millimetre-Wave Computer-Aided Engineering, 1994, 4, (3), pp 230-247]. A summary of some more recent developments can be found in PETOSA, A., ITTIPIBOON, A., ANTAR, Y. M. M., ROSCOE, D., and CUHACI, M.: “Recent advances in Dielectric-Resonator Antenna Technology”, IEEE Antennas and Propagation Magazine, 1998, 40, (3), pp 35-48. DRAs are characterised by a deep, well-defined resonant frequency, although they tend to have broader bandwidth than DLAs. It is possible to broaden the frequency response somewhat by providing an air gap between the dielectric resonator material and the conductive groundplane. In a DRA, it is the dielectric material that acts as the primary radiator, this being due to non-trivial displacement currents generated in the dielectric by the feed.

c) Broadband Dielectric Antenna (BDA): Similar to a DRA, but with little or no conductive groundplane. BDAs have a less well-defined frequency response than DRAs, and are therefore excellent for broadband applications since they operate over a wider range of frequencies. In a BDA, the radiation can arise from the dielectric material, from the dielectrically loaded feed mechanism (which becomes a printed antenna in the area with no conductive groundplane) and from the nearest edge of the conductive groundplane. In some cases the antenna will not be much more complex than a dielectrically loaded printed monopole, but the bandwidth is so very much greater than for conventional DLAs that we have created the separate BDA nomenclature. Generally speaking, the dielectric material in a BDA can take a wide range of shapes, these not being as restricted as for a DRA. Indeed, any arbitrary dielectric shape can be made to radiate in a BDA, and this can be useful when trying to design the antenna to be conformal to its casing.

d) Dielectrically Excited Antenna (DEA): A new type of antenna developed by the present applicant in which a DRA, BDA or DLA is used to excite an electrically conductive radiator. DEAs are well suited to multi-band operation, since the DRA, BDA or DLA can act as an antenna in one band and the conductive radiator can operate in a different band. DEAs are similar to DLAs in that the primary radiator is a conductive component (such as a copper dipole or patch), but unlike DLAs they have no directly connected feed mechanism. DEAs are parasitic conducting antennas that are excited by a nearby DRA, BDA or DLA having its own feed mechanism. There are advantages to this arrangement, as outlined in UK patent application no 0313890.6 of 16th Jun. 2003.

For the avoidance of doubt, the expression “electrically-conductive antenna component” defines a traditional antenna component such as a patch antenna, slot antenna, monopole antenna, dipole antenna, planar inverted-L antenna (PILA), planar inverted-F antenna (PIFA) or any other antenna component that is not an HAD (although in some cases a DLA can be considered to be an electrically-conductive antenna component).

It is also important to distinguish between ordinary resonant antennas and travelling wave structures such as polyrods, and also between travelling wave structures and embodiments of the present invention.

With regard to travelling-wave antennas, W L Stutzman & G A Thiele, “Antenna theory and design”, John Wiley & Sons, inc., 1998 states that: “The wire antennas we have discussed thus far have been resonant structures. The wave travelling outward from the feed point to the end of the wire is reflected, setting up a standing-wave-type current distribution. [An equation is given here to explain this.] If the reflected wave is not strongly present on an antenna this is referred to as a travelling-wave antenna. A travelling-wave antenna acts as a guiding structure for travelling waves, whereas a resonant antenna supports standing waves”, W L Stutzman & G A Thiele, “Antenna theory and design”, John Wiley & Sons, inc., 1998.

With regard to polyrods, J. D. Kraus & R. J. Marhefka, “Antennas for all applications”, Third Edition, McGraw-Hill, 2002, pp 629-630 states that: “A dielectric rod or wire can act as a guide for electromagnetic waves. The guiding action, however, is imperfect since considerable power may escape through the wall of the rod and be radiated. This tendency to radiate is turned to advantage in the polyrod antenna so called because the dielectric rod is usually made of polystyrene”. This book also refers to G. Wilkes “Wavelength lens”, Proc. IRE, 206-212, 1948, who points out that the polyrod acts as an end-fire antenna and may be regarded as a degenerate or rudimentary form of lens antenna. J D Kraus makes the same point in his classic book “Electromagnetics”, Fourth Edition, McGraw-Hill, 1992, pp 771-772. A typical polyrod antenna is disclosed in GB 575,534.

“The handbook of antenna design”, Ed. A. W. Rudge, K. Milne, A. D. Olver & P. Knight, volumes 1 and 2, IEE electromagnetic wave series, Peter Peregrinus, 1996, pp 53 discusses radiation from travelling wave sources. It makes the point that “in many cases the waves are travelling only in one direction . . . examples of this type of antenna are the long wire, the rhombic, dielectric rod . . . ”. Thus it will be clear that polyrods are travelling wave antennas

Purely dielectric antennas are not travelling wave antennas or polyrods. Any antenna made infinitely long will stop being self-resonant and turn into a leaky-wave type of travelling wave antenna. This is because the wave will set off down the antenna and not be reflected from the end (since the antenna is infinitely long). This is as true of pure dielectric antennas as it is of any other type. However, a typical purely dielectric antenna embodied by the present invention, i.e. one having a sensible aspect ratio, will have a self-resonant mechanism and radiate in the same way as an ordinary electrically-conductive metal antenna. As an example, FIG. 5 shows the E-field present on a purely dielectric dipole, and it can be seen that it is operating in a dipolar mode and not as a travelling wave structure (which would have the field steadily decreasing towards the ends).

### BRIEF SUMMARY OF THE DISCLOSURE

At the present time, there appear to be five different ways in which embodiments of the present invention may be implemented:

1) Purely dielectric dipoles and other balanced antennas. These need no groundplane or substrates and would work ‘floating in space’.

2) Purely dielectric monopoles that are driven against a conducting groundplane.

3) Purely dielectric elements that sit on a substrate that is partially covered with a conducting groundplane. Here the radiation mechanism is thought to be more complex as the groundplane plays a significant part in the performance of the antenna and is part of the radiation mechanism. Nonetheless, the driven element remains a purely dielectric device.

4) A hybrid device wherein part of the antenna (generally at the low-impedance feed end) is a purely dielectric radiator and part (generally at the high-impedance open end) is an electrically conductive antenna component.

5) A hybrid device wherein part of the antenna is any of the purely dielectric devices above and a second parasitic device is used to radiate in the same, or a different, frequency band. The parasitic element may be either an electrically conductive antenna component or a type of dielectric antenna.

The work by Richtmyer published in 1939 was to show that suitably shaped objects made of a dielectric material can function as electrical resonators for high frequency oscillations. Richtmyer offered a proof that such a device must radiate based on the boundary conditions at the interface between the dielectric and surrounding medium (air). It had already been suggested earlier that oscillating fields inside a resonator must create outgoing waves and therefore radiated energy [HANSEN W. W. and BERKERLY J. G., Proc. I.R.E., 24, p 1594, 1936]. Richtmyer gave as examples some resonant modes of a dielectric sphere and a circular dielectric ring resonator. On the basis of this work, dielectric resonator antennas (DRAs) were developed in the 1980s as described above.

The present application presents a different interpretation of the work of Richtmyer. The present applicant has surprisingly discovered that another form of resonance can occur in a suitably elongate dielectric material. It has been found that a pair of long thin dielectric pieces can resonate in a similar way to a dipole. This has not been described in any work known to the present applicant, including standard texts on antennas, dielectric resonators or DRAs. Like the DRA resonance modes described by Richtmyer, these dipole-mode resonance dielectrics are also compelled to radiate or they would similarly violate Maxwell's equations as applied to the dielectric-air interface. The present applicant proposes the new nomenclature of Pure(ly) Dielectric Antenna (PDA) for this new technology.

In computer simulations of these purely dielectric dipoles, no electrically conductive component at all is necessary, as a lump-gap source (or other gap feed device) can be placed across the gap between the two arms of the pure dielectric antenna. In some computer simulations the lump gap source does have the same electrical properties as a conductive element, but in general the source is electrically so small that it does not radiate at frequencies of interest. In practice, electrically conductive feed components are needed to test the antennas in the laboratory. However, agreement between purely dielectric simulations and laboratory measurements involving electrically conductive feed networks is good, so the present applicant is convinced that the technology is real and not some simulation or measurement artifact.

A number of significant advantages have been found for PDAs:

i) They have intrinsically very wide bandwidths.

ii) They are more resistant to detuning than conventional antennas.

iii) They have extremely high radiation efficiencies, as there are virtually no loss mechanisms.

iv) They require no, or minimal, matching components (two at the most).

A disadvantage is that they are physically longer than a purely electrically conductive antenna working at the same frequency.

According to a first aspect of the present invention, there is provided an antenna device comprising an elongate dielectric radiating element having a longitudinal axis and a feeding mechanism for generating displacement currents in the dielectric radiating element, the radiating element being configured to support displacement current resonance modes parallel to the longitudinal axis but to inhibit displacement current resonance modes transverse to the longitudinal axis.

It will be apparent that a displacement current resonance mode requires the generation of a standing wave type displacement current distribution, and not a travelling wave type current distribution. Thus, polyrods, dielectric wave guides and other travelling wave antenna structures are specifically excluded from the scope of the present invention.

In some embodiments, the dielectric radiating element may be provided with a conductive grounded substrate, which conductive grounded substrate may have a plane that is substantially perpendicular to the longitudinal axis of the dielectric radiating element.

Embodiments of the present invention may further provide a dipole or other balanced antenna device comprising at least one pair of antennas of the first aspect of the invention, each pair being arranged end-to-end.

The dielectric radiating element may be provided with a dielectric substrate that is partially covered by a conductive groundplane.

The antenna device may further comprise an electrically conductive radiating element attached to the dielectric radiating element.

The feeding mechanism may be a second antenna that excites the dielectric radiating element.

Alternatively or in addition, there may be provided a second radiating element that is parasitically driven by the dielectric radiating element and radiates in the same, or a different, frequency band. The parasitic element may be either an electrically conductive antenna component of a type of dielectric antenna and/or an HDA.

Furthermore, embodiments of the present invention may provide a hybrid antenna device in which a first part of the antenna (generally at a lower impedance feed end) is a purely dielectric radiator and a second part of the antenna (generally at a higher impedance open end) is an electrically conductive radiator.

Current methods of metallising dielectric materials (often ceramic) usually involve some form of conductive paint. Such paint is usually combined with particles of glass and a solvent. For ceramics, the combination is heated in an oven at around 900° C., and during this process the glass material separates towards the ceramic and infuses therewith while the conductive material (often silver) diffuses towards the surface. After cooling, the ceramic has a conductive surface strongly bonded thereto. Other methods of making an electrical connection to dielectric material include mechanically attaching conductive material and bonding conductive material by means of adhesive.

Embodiments of the present invention may employ a new method of attaching electrical conductors to dielectrics by means of intercalation. Intercalation is a term used in chemistry for the inclusion of a guest ion or molecule (or group) between two other host ions or molecules (or groups). The host material usually has some form of lattice or other periodic network. If conductive ions or molecules (or groups) are inserted in the host structure, the host dielectric will then become conductive at that point and an electrical connection may be made. This new technique might be applied to any material but is of particular interest when it is intended to keep a dielectric material as pure as possible, particularly for purely dielectric antennas.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

### BRIEF DESCRIPTION OF THE DRAWINGS

For a better understanding of the present invention and to show how it may be carried into effect, reference shall now be made by way of example to the accompanying drawings, in which:

FIG. 1 shows a simulated model of a ceramic dipole of an embodiment of the present invention in free space;

FIG. 2 shows a real-life embodiment of the dipole of FIG. 1 mounted on a dielectric substrate and provided with a microstrip balun;

FIG. 3 shows the unmatched return loss—calculated (solid line) and measured (dashed line)—for the embodiments of FIGS. 1 and 2;

FIG. 4 shows a plot of the matched return loss—calculated (solid line) and measured (dashed line)—for the embodiments of FIGS. 1 and 2;

FIG. 5 shows the E-field present on a purely dielectric dipole of the type shown in FIG. 1 or 2;

FIG. 6 shows a simulated model of a bi-conical purely dielectric dipole of an embodiment of the present invention;

FIG. 7 shows a plot of the matched return loss for the embodiment of FIG. 6 (solid line) and an alternative embodiment in which the dipoles have constant radius but identical volume (dashed line);

FIG. 8 shows a monopole purely dielectric antenna mounted on an effectively infinite groundplane;

FIG. 9 shows a plot of the unmatched return loss (solid line) and matched return loss (dashed line) for the embodiment of FIG. 8;

FIG. 10 shows an embodiment of the present invention suited to WLAN applications;

FIG. 11 shows an embodiment of the present invention suited to broadband GSM radio applications;

FIG. 12 shows a plot of the return loss for first and second ports of the embodiment of FIG. 10;

FIG. 13 shows a plot of the return loss for the embodiment of FIG. 11;

FIG. 14 shows a dipole comprising a pair of hybrid elements, each being formed of a purely dielectric portion and an electrically conductive portion;

FIG. 15 shows an embodiment of the present invention in which a dipole PDA drives a parasitic or secondary PDA; and

FIG. 16 shows a plot of the return loss for the embodiment of FIG. 15, with the dashed line showing the return loss when the parasitic PDA is present, and the solid line showing the return loss when the parasitic PDA is absent.

### DETAILED DESCRIPTION

### 1) Purely Dielectric Dipoles and Other Balanced Antennas

A description of the basic technology will now be given using as an example a purely dielectric dipole antenna of a first variation of embodiments of the present invention.

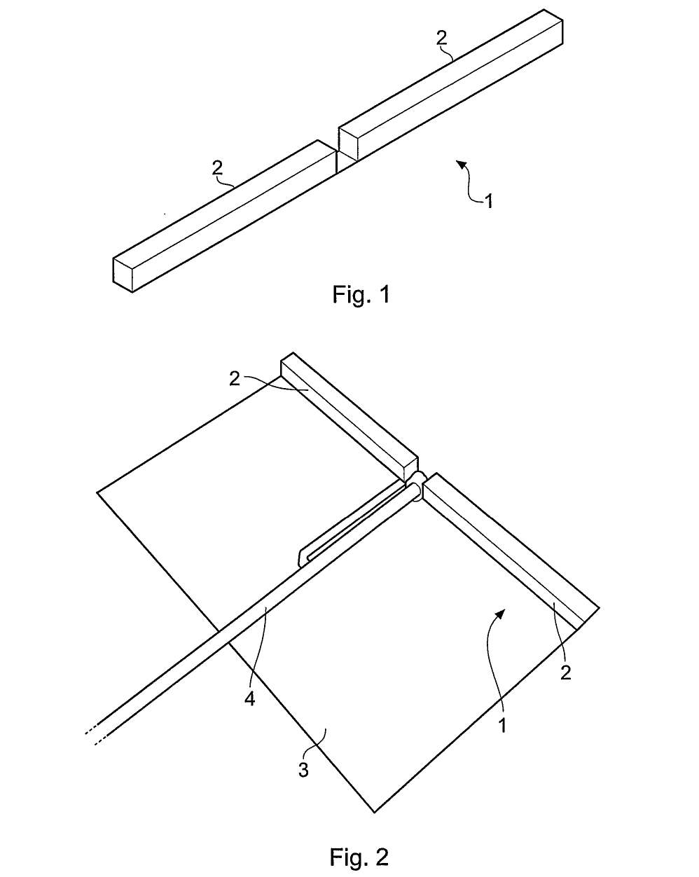

FIG. 1 shows a simulated ceramic dipole 1 in free-space, the dipole having a pair of co-linear radiating arms 2.

FIG. 2 shows a practical realization of the concept shown in FIG. 1, in the form of a dipole 1 comprising a pair of oblong dielectric ceramic elements 2 mounted along a line on a Duroid® substrate 3 (εᵣ≈2.2) with a micro-strip balun 4.

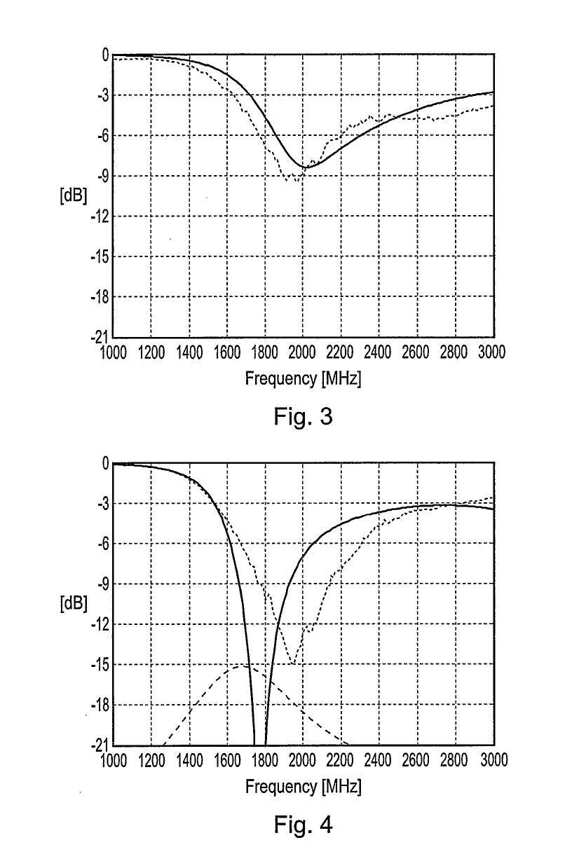

FIG. 3 shows the matched return loss—calculated (solid line) and measured (dashed line) for the embodiments of FIGS. 1 and 2 respectively, while FIG. 4 shows the unmatched return loss plots.

For this antenna it has been found that increasing the dimensions causes a decrease in resonant frequency exactly in inverse proportion. Thus an antenna with a dielectric constant (εᵣ) of 135 and arms 2 measuring 1×1×20 mm resonates at 4320 MHz whereas one measuring 5×5×100 mm is found to resonate at 900 MHz, which is almost exactly in proportion. This behaviour is consistent with that of a dipole, or any other radiating device, in which frequency and dimension should scale inversely.

Increasing the cross-section of the antenna, at constant length, causes an increase in volume but no great decrease in resonant frequency. For example, an antenna with εᵣ=135 and arms 2 measuring 1×1×20 mm resonates at 4320 MHz whereas one measuring 5×5×20 mm is found to resonate at 2750 MHz. So although the volume has increased 25-fold, the frequency has only decreased to about 64% of 4320 MHz. This is completely inconsistent with a DRA, where the resonant frequency is linearly dependent on volume (over the range of aspect ratios commonly examined) and is much more consistent. This is a key difference between PDAs and DRAs.

An increase in εᵣ causes a decrease in resonant frequency nearly, but not exactly, in proportion to the square root of the dielectric constant. Thus an antenna with arms 2 measuring 2×2×20 mm and an εᵣ of 40 may be found to resonate at 4320 MHz, while one of the same dimensions with an εᵣ of 200 is found to resonate at 2090 MHz.

Bandwidth is not found to be a strong function of εᵣ over the range examined. However, bandwidth rises almost linearly with the cross-section of the arms 2 for a fixed length. For example, an antenna with arms 2 measuring 1×1×40 mm has a bandwidth of 15.3%, but one with arms 2 measuring 5×5×40 mm has a bandwidth of 39%. Bandwidth is a function of εᵣ, but not a strong function. For example, an antenna with arms 2 measuring 4×4×20 and an εᵣ of 37 has a bandwidth of 38.5%, but when the εᵣ is increased to 200 the bandwidth falls only to 24.4%, a factor of 0.63. This is very much lower than for any known DRA resonant mode, see [MONGIA, R. K. and BHARTIA, P.: “Dielectric Resonator Antennas—A Review and General Design Relations for Resonant Frequency and Bandwidth”, International Journal of Microwave and Millimetre-Wave Computer-Aided Engineering, 1994, 4, (3), pp 230-247]. This weak dependence of bandwidth on εᵣ is another key difference between PDAs and DRAs.

When the resonant structures in PDAs are examined, it is clear that the antenna behaves similarly to an electrically conductive dipole with the exception that the field can exist inside the dielectric as well as on the surface. This gives rise to a longitudinal resonant mode, unlike DRAs which have cavity-like resonant modes. This supports the assertion of the present applicant that PDAs of the present invention are fundamentally different from DRAs of the prior art.

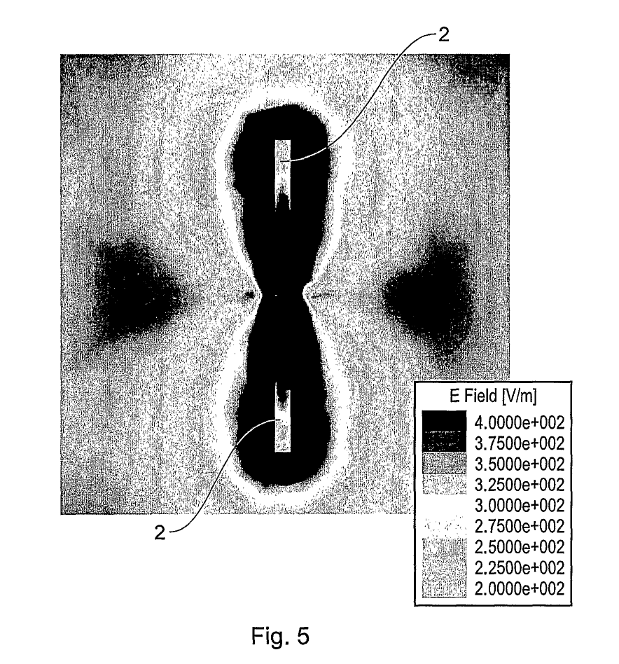

FIG. 5 shows the E-field measured on the embodiment of FIG. 2, from which it can be seen that the dipole is operating in a dipolar mode rather than in a travelling wave mode (in which case the E-field would steadily decrease towards the ends of the dipole).

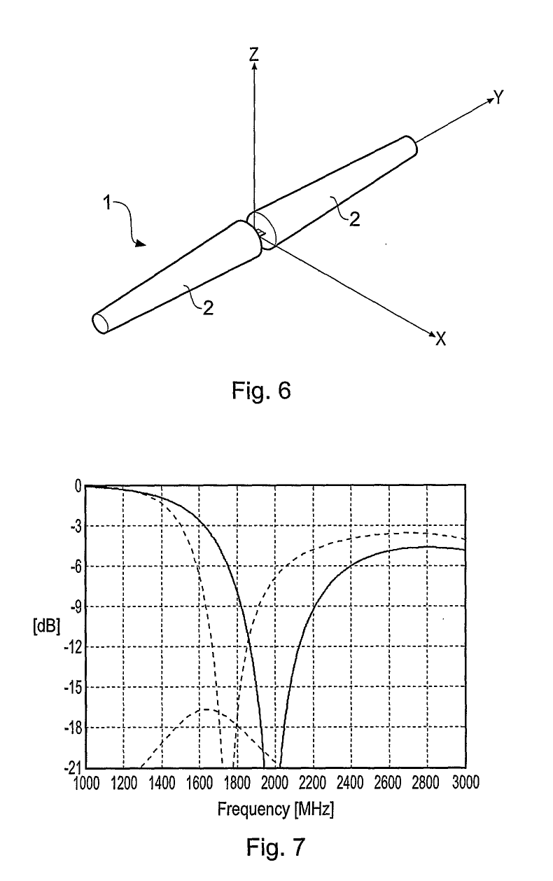

FIG. 6 shows an embodiment similar to that of FIG. 1, except in that the arms 2 are configured with a conical or frustoconical shape with their wider bases facing each other. In this simulated model of a bi-conical PDA (εᵣ=93), the arms 2 each have a start radius of 4 mm and an end radius of 2 mm (i.e. a radius ratio of 2:1).

FIG. 7 shows a plot of the matched return loss for the embodiment of FIG. 6 (solid line) and an alternative embodiment in which the dipoles have constant radius but identical volume (dashed line).

In computer simulations, the bandwidth improvement of the bi-conical PDA of FIG. 6 was 9.6% greater than the equivalent constant radius dipole (see FIG. 7). It also had a slight increase in the centre frequency at resonance.

### 2) Purely Dielectric Monopoles and Other Unbalanced Antennas

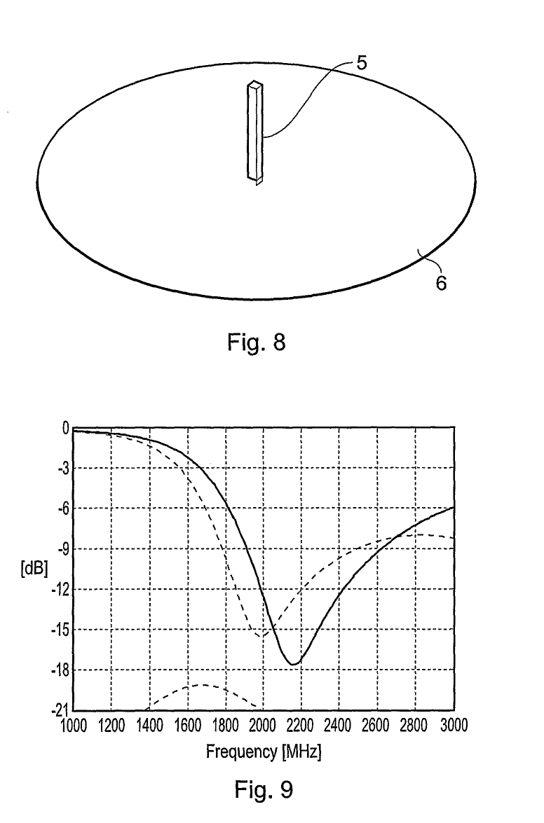

FIG. 8 shows a monopole dielectric ceramic element 5 mounted generally perpendicular to an effectively infinite groundplane 6.

In the particular example investigated by the present applicant, the monopole element 5 was of dimensions 4×4×40 mm on an effectively infinite ground-plane.

The monopole PDA exhibits a much wider bandwidth than its balanced counterpart at roughly the same frequency. For example, one arm of PDA dipole that has a centre frequency of 1800 MHz and a matched bandwidth of approximately 440 MHz can be used as a monopole with a frequency of around 2100 MHz and a bandwidth >1300 MHz, given the correct matching.

FIG. 9 shows a plot of the unmatched return loss (solid line) and matched return loss (dashed line) for the embodiment of FIG. 8.

### 3) Purely Dielectric Elements Located On A Substrate Partially Covered with a Conductive Groundplane

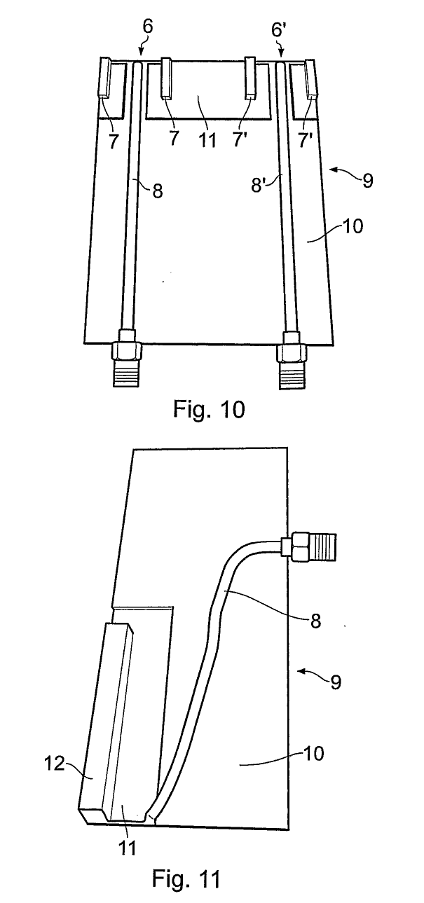

FIG. 10 shows an embodiment comprising a first antenna 6 having first and second purely dielectric arms 7 fed by a microstrip balun 8, and a second antenna 6′ having first and second purely dielectric arms 7′ fed by a microstrip balun 8′. In this embodiment, the arms 7 are arranged in a mutually parallel configuration, one on either side of the balun 8, as are the arms 7′ in relation to the balun 8′. The antennas 6, 6′ are mounted on a dielectric substrate 9 with a conductive groundplane 10 being formed on its upper surface except for a region 11 on which the arms 7, 7′ are located. The groundplane 10 does extend under the microstrip feeds 8, 8′ and between the respective arms 7, 7′.

The embodiment of FIG. 10 has been designed as a broadband or multiband WLAN antenna for use in laptop computers, with antenna 6 operating in one band and antenna 6′ operating in a different, adjacent band (for broadband) or non-overlapping band (for multiband).

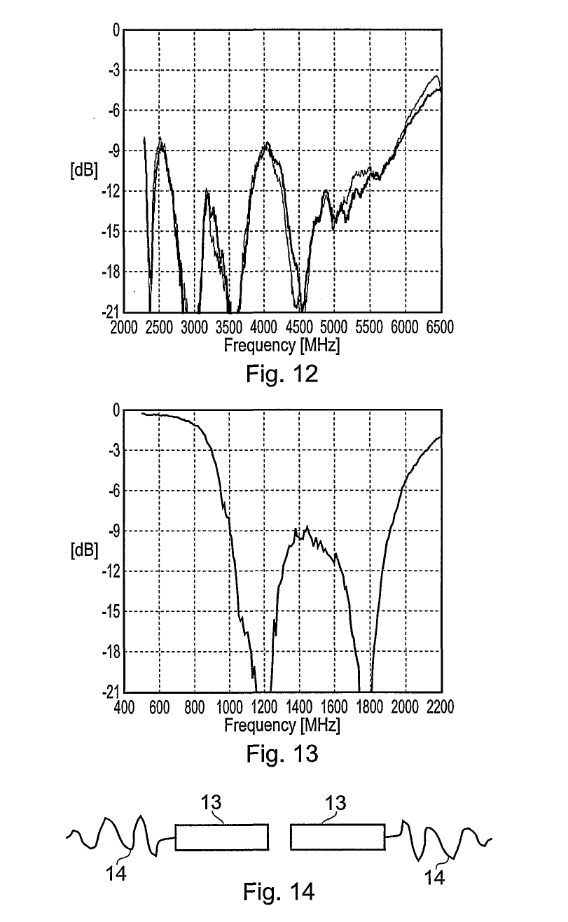

FIG. 12 shows the return loss for the antennas 6, 6′ respectively of the embodiment of FIG. 10, and show how multiband operation can be achieved.

FIG. 11 shows a further embodiment in which a purely dielectric monopole radiating element 12 is mounted on a dielectric substrate 9 with a conductive groundplane 10 formed on its upper surface except for a region in which the element 12 is located. This embodiment is designed for broadband GSM radio applications. The width of the groundplane 10 can be changed in order to move from a broadband to a dual-band resonance and vice-versa.

FIG. 13 shows the return loss for the embodiment of FIG. 11.

### 4) A Hybrid Device Wherein Part of the Antenna (Generally at the Low-Impedance Feed End) is a Purely Dielectric Radiator and Part (Generally at the High-Impedance Open End) is an Electrically Conductive Antenna Component

FIG. 14 shows, in schematic form, a variation of the embodiments of FIG. 1, 2 or 6, wherein the dielectric arms (shown here as 13) are provided with conductive extensions 14 (e.g. copper wires or the like) at the ends of the arms 13 that are not provided with a feed (not shown). The idea is that the dipole comprising the dielectric arms 13 is configured to resonate with a wide bandwidth in a high frequency band and the conductive extensions 14 are added so as to radiate (generally with lower bandwidth) in a lower band. The conductive extensions 14 may be straight, or may have a meandering configuration as shown. The order may be reversed such that the purely dielectric elements 13 are extensions of a conventional conductive dipole with conductive arms 14.

### 5) A Hybrid Device Wherein Part of the Antenna is Any of the Purely Dielectric Devices Above and a Second Parasitic Device is Used to Radiate in the Same, or a Different, Frequency Band

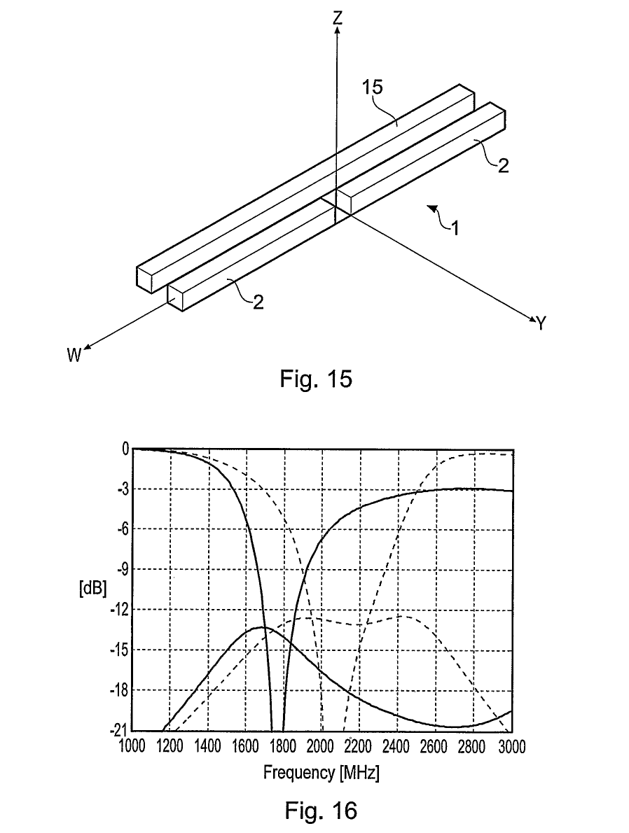

FIG. 15 shows a purely dielectric dipole 1 (similar to that of FIG. 1) having a pair of dielectric radiating arms 2. There is further provided a purely dielectric ceramic parasitic element 15 located parallel and close to the dipole 1.

FIG. 16 shows the return loss plot for the embodiment of FIG. 15, with the dashed lines showing the return loss when the parasitic element 15 is present, and the solid lines showing the return loss when the parasitic element 15 is removed. It can be seen that the presence of the parasitic element 15 results in greater bandwidth.

Instead of using a parasitic PDA 15, a conductive parasitic antenna element may be provided, since there is clearly sufficient coupling.

Moreover, a conductive dipole may be provided with a parasitic PDA in a similar manner.

1. An antenna device comprising an elongate dielectric radiating element having a longitudinal axis and a feeding mechanism for generating displacement currents in the dielectric radiating element, the radiating element being configured to support displacement current resonance modes parallel to the longitudinal axis but to inhibit displacement current resonance modes transverse to the longitudinal axis.

2. An antenna as claimed in claim 1, configured to support resonance modes generated by standing wave type displacement current distributions.

3. An antenna as claimed in claim 1, wherein the dielectric radiating element is provided with a conductive grounded substrate.

4. An antenna as claimed in claim 3, wherein the conductive grounded substrate has a plane that is substantially perpendicular to the longitudinal axis of the dielectric radiating element.

5. An antenna as claimed in claim 3, wherein the conductive grounded substrate has a plane that is substantially parallel to the longitudinal axis of the dielectric radiating element.

6. A dipole or other balanced antenna device comprising at least one pair of antennas as claimed in any one of claims 1, each pair being arranged end-to-end.

7. A monopole or other unbalanced antenna device comprising an antenna as claimed in claim 4

8. An antenna as claimed in claim 1, wherein the dielectric radiating element is provided with a dielectric substrate that is partially coveted by a conductive groundplane.

9. An antenna as claimed in claim 8, wherein the dielectric radiating element is located on a part of the dielectric substrate that is not coveted by the conductive groundplane.

10. An antenna as claimed in claim 8, comprising at least one pair of dielectric radiating elements.

11. An antenna as claimed in claim 10, wherein the at least one pail of dielectric radiating elements are arranged in a substantially parallel configuration

12. An antenna as claimed in claim 10, wherein the at least one pail of dielectric radiating elements are arranged in a substantially co-linear configuration.

13. An antenna as claimed in claim 10, wherein the at least one pair of dielectric radiating elements is fed by a balun feed.

14. An antenna device as claimed in claim 1, further comprising an electrically conductive radiating element attached to the dielectric radiating element.

15. An antenna as claimed in claim 14, wherein the electrically conductive radiating element extends in the same direction as the longitudinal axis of the dielectric radiating element.

16. An antenna as claimed in claim 14, wherein the electrically conductive radiating element is attached at an end of the dielectric element remote from the feeding mechanism.

17. An antenna as claimed in claim 14, wherein the electrically conductive radiating element is attached at an end of the dielectric element proximate to the feeding mechanism.

18. An antenna as claimed in any preceding claim, wherein the dielectric radiating element has an elongate oblong configuration.

19. An antenna as claimed in claim 1, wherein the dielectric radiating element has an elongate cylindrical configuration.

20. An antenna as claimed in claim 1, wherein the dielectric radiating element has an elongate conical or frustoconical configuration.

21. An antenna device as claimed in claim 1, wherein the feeding mechanism is a second antenna that excites the dielectric radiating element

22. An antenna device as claimed in claim 1, wherein there is provided a second radiating element that is parasitically driven by the dielectric radiating element.

23. An antenna device as claimed in claim 1, wherein the dielectric radiating element is made of a dielectric ceramics material.

24. An antenna device as claimed in claim 1, wherein the feed mechanism is attached to the dielectric resonator by means of intercalation.

25. (canceled)
